(19) United States
(12) Patent Application Publication
(10) Pub. No.: US 2026/0197786 A1
(43) Pub. Date: Jul. 9, 2026

(54) METHODS, ARCHITECTURES, APPARATUSES AND SYSTEMS FOR STANDALONE NON-PUBLIC NETWORK PUBLIC LAND MOBILE NETWORK INTERWORKING

(71) Applicant: InterDigital Patent Holdings, Inc., Wilmington, DE (US)

(72) Inventors: Anuj Sethi, Ottawa (CA); Guanzhou Wang, Brossard (CA); Michael Starsinic, Newtown, PA (US); Catalina Mladin, Hatboro, PA (US); Taimoor Abbas, Sainte-Julie (CA); Rocco Di Girolamo, Laval (CA)

(21) Appl. No.: 19/014,522

(22) Filed: Jan. 9, 2025

(51) Int. Cl. H04W 60/00; H04W 48/20

(52) U.S. Cl. CPC H04W 60/00; H04W 48/20

(57) ABSTRACT

A method, implemented in a WTRU is described herein. The method may include sending a request message to a first network element of a first network, the request message indicating at least one of (i) a capability of the WTRU to support unified network selection and (ii) one or more second networks, receiving a response message from the first network element of the first network, the response message indicating (i) that unified network selection may be supported by the first network and (ii) a list of second networks, selecting a cell associated with a second network of the list of second networks, and sending a registration message to a second network element of the second network via the selected cell using credentials that may have been used to register with the first network.

### TECHNICAL FIELD

The present disclosure is generally directed to the fields of communications, software and encoding, including methods, architectures, apparatuses, and systems directed to standalone non-public network (SNPN) public land mobile network (PLMN) interworking.

### BACKGROUND

A non-public network (NPN) is a fifth-generation system (5GS) deployed network which is for non-public use. A 5G standalone non-public network (5G SNPN) is based on the architecture of 5GS. A 5G SNPN has its own subscription and credentials. Embodiments described herein have been designed with the foregoing in mind.

### SUMMARY

Methods, architectures, apparatuses, and systems directed to standalone non-public network (SNPN) public land mobile network (PLMN) interworking are described herein. In an embodiment, a wireless transmit/receive unit (WTRU) is described. The WTRU may include circuitry including a transmitter, a receiver, a processor, and memory. The WTRU may be configured to send a request message to a first network element of a first network. In various embodiments, the request message may indicate at least one of (i) a capability of the WTRU to support unified network selection and (ii) one or more second networks. The WTRU may be configured to receive a response message from the first network element of the first network. In various embodiments, the response message may indicate (i) that unified network selection may be supported by the first network and (ii) a list of second networks. The WTRU may be configured to select a cell associated with a second network of the list of second networks and send a registration message to a second network element of the second network via the selected cell using credentials that may have been used to register with the first network.

In an embodiment, a method implemented in a WTRU is described. The method may include sending a request message to a first network element of a first network. In various embodiments, the request message may indicate at least one of (i) a capability of the WTRU to support unified network selection and (ii) one or more second networks. The method may include receiving a response message from the first network element of the first network. In various embodiments, the response message may indicate (i) that unified network selection may be supported by the first network and (ii) a list of second networks. The method may include selecting a cell associated with a second network of the list of second networks and sending a registration message to a second network element of the second network via the selected cell using credentials that may have been used to register with the first network In an embodiment, a network element is described. The network element may include circuitry including a transmitter, a receiver, a processor, and memory. The network element may be configured to receive a request message from a WTRU. In various embodiments, the request message may indicate at least one of (i) a capability of the WTRU to support unified network selection and (ii) one or more second networks. The network element may be configured to determine a list of second networks with which the first network may have roaming agreements and determine a mobility restriction list comprising information about the list of second networks. The network element may be configured to send the mobility restriction list to a base station of the first network serving the WTRU. In various embodiments, the mobility restriction list may be to be used by the base station to allow a handover of the WTRU to the list of second networks. The network element may be configured to send a response message to the WTRU. In various embodiments, the response message may indicate (i) that unified network selection may be supported by the first network and (ii) the list of second networks.

In an embodiment, a method implemented in a network element is described. The method may include receiving a request message from a WTRU. In various embodiments, the request message may indicate at least one of (i) a capability of the WTRU to support unified network selection and (ii) one or more second networks. The method may include determining a list of second networks with which the first network may have roaming agreements and determining a mobility restriction list comprising information about the list of second networks. The method may include sending the mobility restriction list to a base station of the first network serving the WTRU. In various embodiments, the mobility restriction list may be to be used by the base station to allow a handover of the WTRU to the list of second networks. The method may include sending a response message to the WTRU. In various embodiments, the response message may indicate (i) that unified network selection may be supported by the first network and (ii) the list of second networks.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating the 5G system architecture in the non-roaming case;

FIG. 3 is a diagram illustrating the 5G system architecture in the roaming case;

FIG. 4 is a diagram illustrating the 5G system roaming architecture in the case of home routed scenario;

FIG. 5 is a diagram illustrating the 5G system roaming architecture in the case of local break out scenario using the reference point representation for SNPN and PLMN interworking;

FIG. 6 is a diagram illustrating the 5G system roaming architecture in the case of home routed scenario using the reference point representation for SNPN and PLMN interworking;

FIG. 7 is a diagram illustrating registration and mobility management aspects for SNPN-PLMN interworking;

FIG. 8 is a diagram illustrating an example method for SNPN-PLMN interworking in a WTRU; and

FIG. 9 is a diagram illustrating an example method for SNPN-PLMN interworking in a network element.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

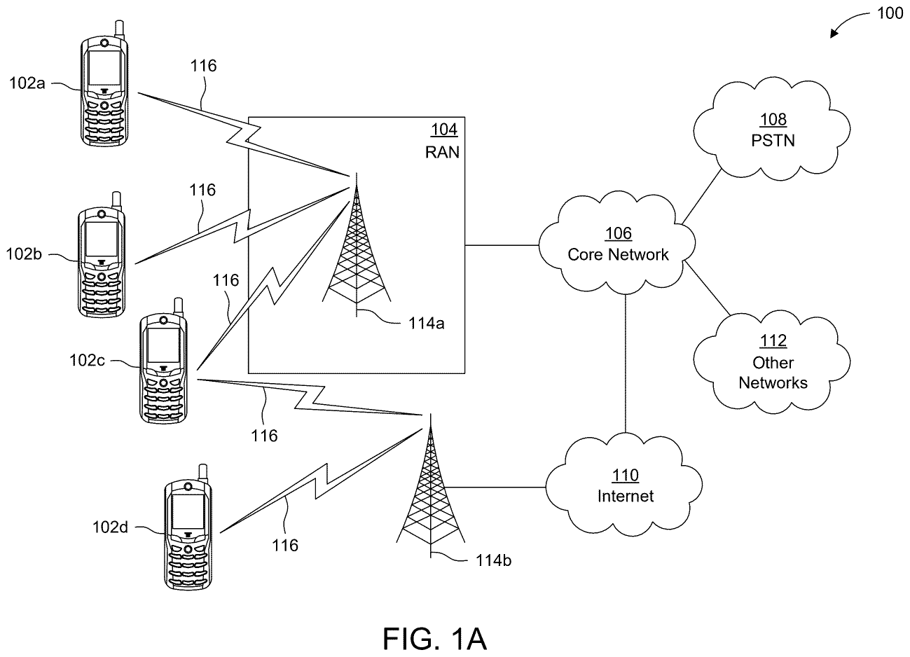

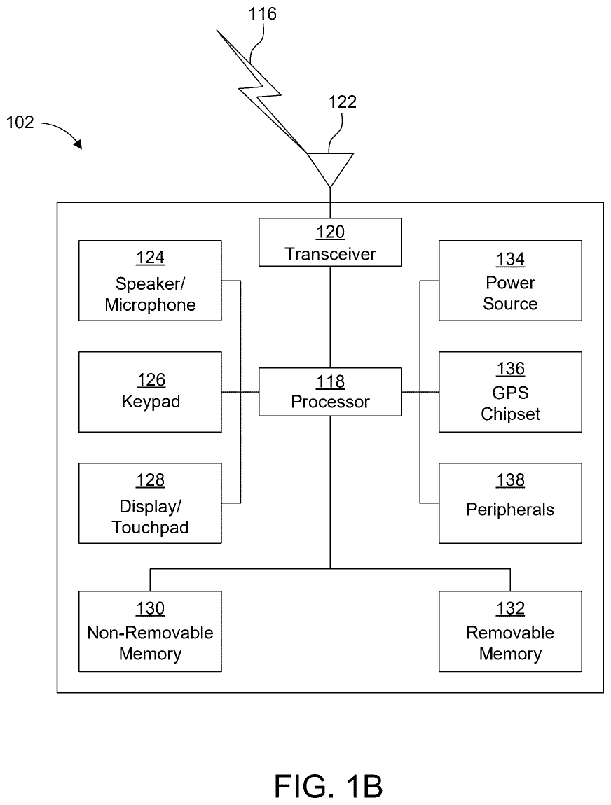

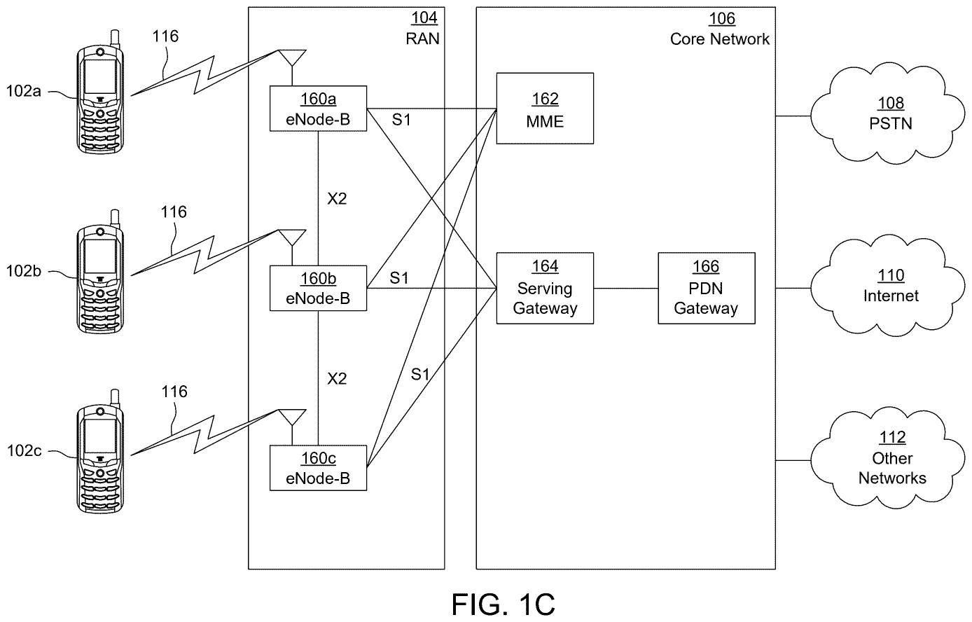

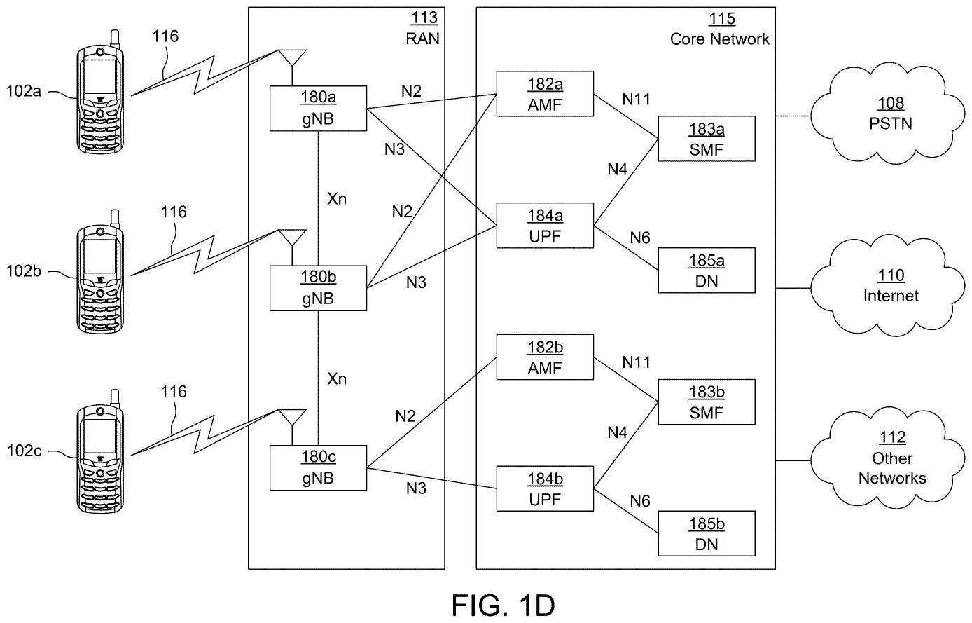

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11 ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b, e.g., to customize CN support for WTRUs 102a, 102b, 102c based on the types of services being utilized by WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184a, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Throughout embodiments described herein the terms “base station”, “network”, “cell”, and “gNB”, collectively “the network” may be used interchangeably to designate any network element such as e.g., a network element acting as a serving base station. Embodiments described herein are not limited to gNBs and are applicable to any other type of base stations.

For the sake of clarity, satisfying, failing to satisfy a condition, and configuring condition parameter(s) are described throughout embodiments described herein as relative to a threshold (e.g., greater, or lower than) a (e.g., threshold) value, configuring the (e.g., threshold) value, etc. For example, satisfying a condition may be described as being above a (e.g., threshold) value, and failing to satisfy a condition may be described as being below a (e.g., threshold) value. Embodiments described herein are not limited to threshold-based conditions. Any kind of other condition and parameter(s) (such as e.g., belonging or not belonging to a range of values) may be applicable to embodiments described herein.

Throughout embodiments described herein, (e.g., configuration) information may be described as received by a WTRU from the network, for example, through system information or via any kind of protocol message. Although not explicitly mentioned throughout embodiments described herein, the same (e.g., configuration) information may be pre-configured in the WTRU (e.g., via any kind of pre-configuration methods such as e.g., via factory settings), such that this (e.g., configuration) information may be used by the WTRU without being received from the network.

Throughout embodiments described herein, the expression “the WTRU may be configured with a set of parameters” is equivalent or may be used interchangeably with “the WTRU may receive configuration information (e.g., from another network element (e.g., gNB)) indicating a set of parameters”. Throughout embodiments described herein, the expressions “the WTRU may report something”, and “the WTRU may be configured to report something”, is equivalent or may be used interchangeably with “the WTRU may transmit (e.g., reporting) information indicating something”. Throughout embodiments described herein, the expression “the WTRU may provide (/be provided) with a set of parameters (/something)” is equivalent or may be used interchangeably with “the WTRU may transmit (/receive) information indicating a set of parameters (/something)”.

In embodiments described herein, “a” and “an” and similar phrases are to be interpreted as “one or more” and “at least one”. Similarly, any term which ends with the suffix “(s)” is to be interpreted as “one or more” and “at least one”. The term “may” is to be interpreted as “may, for example”.

A symbol “/” (e.g., forward slash) may be used herein to represent “and/or”, where for example, “A/B” may imply “A and/or B”.

In embodiments described herein, “list of”, “set of” and “one or more of” may be used interchangeably.

In embodiments described herein, “identity” and “identifier” may be used interchangeably to refer to how a network element (or a WTRU) may be identified.

In embodiments described herein, a network element may refer to any kind of device including computing resources and networking capabilities, that may be connected to a network. The terms network element and node may be used interchangeably. A network element may be any kind of network infrastructure device and or a WTRU. The architecture depicted at FIG. 1B for a WTRU 102 may be applicable more generally to any kind of network element.

In embodiments described herein, the term base station and cell may be used interchangeably.

### Terminology A standalone non-public network (SNPN) may refer to a non-public network (NPN) not relying on network functions provided by a PLMN.

A public network integrated NPN may refer to a non-public network deployed with the support of a PLMN.

Service continuity may refer to an uninterrupted user experience of a service, including the cases where the internet protocol (IP) address and/or anchoring point may change.

Session continuity may refer to the continuity of a PDU session. For PDU session of IPv4 or IPv6 or IPv4v6 type, “session continuity” may imply that the IP address may be preserved for the lifetime of the PDU session.

SNPN access mode may refer to an operating mode of a WTRU in which the WTRU may select (e.g., only) standalone non-public networks over supported interfaces. This may also be referred to as SNPN access operating mode.

SNPN-enabled WTRU may refer to a WTRU configured to use standalone non-public networks.

Service based interface may represent how a set of services may be provided/exposed by a (e.g., given) network function (NF).

SMF service area may refer to the collection of UPF service areas of (e.g., all) UPFs which can be controlled by one SMF.

SNPN identifier (ID) may refer to PLMN ID and network identifier (NID) identifying an SNPN.

Local break out (LBO) may refer to a roaming scenario for a PDU session where the PDU session anchor and its controlling SMF may be located in the serving PLMN (visited public land mobile network (VPLMN)).

PLMN selection mode may refer to an operating mode of a WTRU in which the WTRU may select (e.g., only) PLMNs over supported interfaces.

For the sake of clarity, embodiments are described herein with a PLMN and a SNPN as examples of a first network and a second network. Embodiments described herein are not limited to a PLMN and a SNPN and may be applicable to any kind of first network and second network over which a WTRU may be roaming.

### SNPN PLMN Interworking Overview

WTRU actions for SNPN-PLMN interworking are described herein.

The WTRU may send a (e.g., NAS) message to a first network element (e.g., AMF) of a first network (e.g., PLMN) via a base station. The (e.g., NAS) message may include an indication that the WTRU may support unified network selection mode. The (e.g., NAS) message may indicate one or more second networks (which may be referred to as SNPN identities) as described in the following examples.

In a first example, the SNPN identities may include the identities of SNPNs that the WTRU may have detected.

In a second example, the SNPN identities may include the identities of SNPNs that the WTRU may expect to connect to e.g., in order to access services.

In a third example, the SNPN identities may include the identities of SNPNs that the WTRU may have detected and may expect to connect to e.g., in order to access services.

Detecting an SNPN may refer to the WTRU determining that (e.g., it may have detected that) a base station is broadcasting an identifier that may be associated with the SNPN.

In an example, the base station may be broadcasting a PLMN ID.

The WTRU may receive a (e.g., NAS) message from the AMF. The (e.g., NAS) message may include an indication (e.g., indicate) any of (i) that unified network selection mode may be supported, (ii) an (e.g., enhanced) tracking area identity (TAI) list, (iii) an (e.g., enhanced) equivalent network list, and (iv) a (e.g., preferred) network list. If the list is a TAI list, the list may include a list of one or more tracking area identities that may be associated with SNPNs and PLMNs. The TAI belonging to SNPN or PLMN may be part of the (e.g., enhanced) equivalent network list (the list may contain SNPN and PLMN identifiers).

Unified network selection mode may be indicated as supported by the AMF. This may indicate that the AMF may have roaming agreements with SNPN and may allow the WTRU to operate in the unified network selection mode enabling the WTRU to camp on any available suitable cells belonging to SNPN/PLMN.

To reduce the tracking area updating signaling within the 5GS, the AMF may assign several tracking areas to the WTRU as part of the (e.g., enhanced) TAI list. The WTRU may consider itself registered to a list of tracking areas and may not (e.g., need to) trigger the registration procedure for mobility and periodic registration update used for mobility (e.g., “mobility registration updating” in the registration request message) as long as the WTRU stays in one of the tracking areas of the (e.g., enhanced) TAI list received from the AMF.

An (e.g., enhanced) equivalent network list may include the list of PLMN/SNPNs which may be considered equivalent to each other. This means that from the WTRU perspective they may be same networks, and the WTRU may seamlessly roam among them, for example, for the purpose of idle mode cell selection and reselection.

An (e.g., enhanced) network selection list may include a prioritized list of PLMNs/SNPNs e.g., configured by the home operator (home public land mobile network (HPLMN)) taking into consideration provisioned policies e.g., received from other PLMN/SNPN operators.

The WTRU may perform a cell (re) selection procedure and, in the cell (re) selection procedure, may prioritize the cells that may broadcast a tracking area identity that may be associated with the (e.g., enhanced) TAI list. The cells of the list may be prioritized based on the cells of the list being used to access services of an SNPN or an PLMN.

The WTRU may send a registration message via the selected cell.

### Non-Public Networks

A on-public network (NPN) is a 5GS deployed network which is for non-public use, as described in third generation partnership project (3GPP) technical specification (TS) 22.261 v19.8.0. An NPN may be any of (i) a standalone non-public network (SNPN), e.g., operated by an NPN operator and not relying on network functions provided by a PLMN, and (ii) a public network integrated NPN (PNI-NPN), e.g., a non-public network deployed with the support of a PLMN.

A non-public network (NPN) may be intended for the use of a private entity such as any of an enterprise and a factory. A SNPN may be identified by a combination of PLMN ID and a network identifier (NID), where the PLMN ID may be e.g. reserved PLMN IDs for private networks (e.g., with mobile country code=999).

The architecture of a 5G SNPN is based on the architecture of 5G system as depicted in clause 4.2.3 of 3GPP TS 23.501 V 19.1.0. The next generation (NG)-RANs of the SNPN may broadcast the combination of PLMN IDs and NIDs. A WTRU operating in SNPN access mode may read the broadcast system information for available (PLMN ID+NID)'s and may select the SNPN for which it may have subscription and credentials.

### Public Network Integrated Non-Public Network (PNI-NPN)

A PNI-NPN is a non-public network made available using PLMN infrastructure/resources, such as e.g., a PLMN network slice. A group of PLMN users which may be allowed to access a (e.g., certain) PNI-NPN may be referred to as a close access group (CAG). A CAG may be identified by a CAG identifier. CAG users can (e.g., only) access a PNI-NPN from a cell supporting CAG access, which may be referred to as a “CAG cell”. A CAG cell may broadcast a list of CAG identifiers that it may support. A CAG WTRU may be configured by the network with a list of CAGs that it may access (allowed CAG list). When a CAG WTRU detects a CAG cell, it can (e.g., only) select/access the CAG cell if at least one of the broadcasted CAG identifier(s) matches one of the CAG identifiers in its allowed CAG list.

### 5G Networks Providing Access to Localized Services (PALS Network)

A cellular network may be deployed to provide services to local users within a certain area. For example, a temporary non-public cellular network may be set up to provide a streaming video service to the audience in a live concert or a football match. In another example, in places like airports, shopping malls and school campuses, where a large crowd may gather, cellular networks may be deployed to provide localized services, such as commercial ads in the shopping mall. The services provided by these small networks may have two main characteristics: first, the services may be localized, meaning that they may be related to the activities/events in a certain spot or area, and may be limited to the users within the area; second, the users may not utilize these services on a regular basis and most likely in on-demand or temporary fashion.

5G system enhancements may be desired to provide such localized services and enable users to access the hosting network that provides those services. This aspect is further described in 3GPP S1-203276. In this document, those localized services are referred to as “PALS service” or “localized services”, and the network that provides PALS services is referred to as “PALS network” or “PALS hosting network” or simply “hosting network”.

A hosting network may be any of a SNPN, a PNI-NPN, and a PLMN. The local service provider may be the hosting network operator or a third party service provider.

### 5GS Reference Architecture

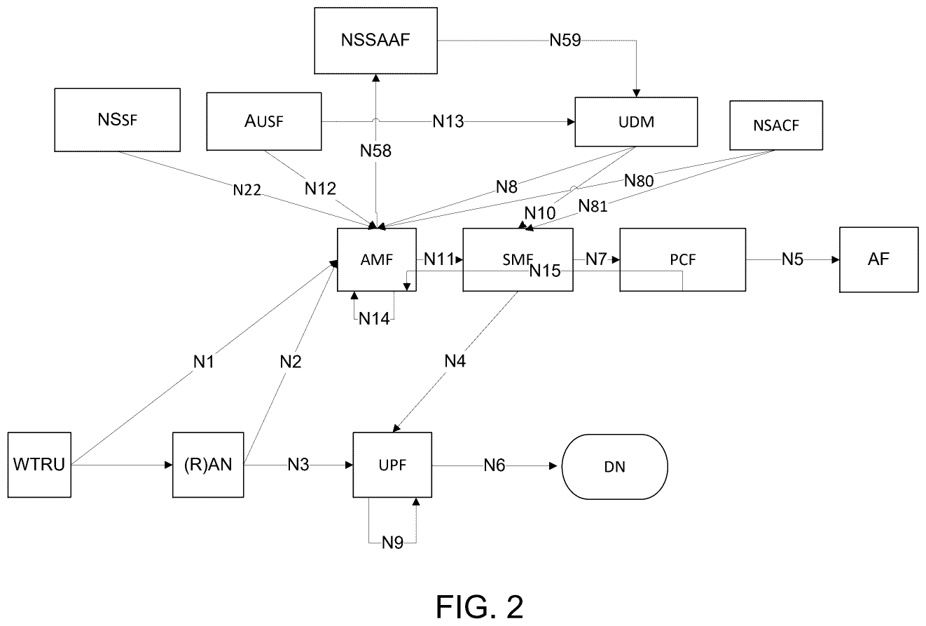

FIG. 2 is a diagram illustrating the 5G system architecture in the non-roaming case. The reference point representation N1-N15, N22, N58, N59, N80, N81 shows how various network functions may interact with each other.

In 5G roaming scenarios, PDU sessions may be local breakout (LBO) based or home routed (HR) based. LBO PDU sessions and HR PDU sessions mainly differ in the way user data may be handled in the involved network elements.

LBO PDU sessions may be established when the WTRU is in the visited network. During PDU session establishment, a UPF that is part of the visited network may be selected to serve as an anchor for the PDU session. User data traffic may move from the UPF in the visited network to the external data network. An SMF and UPF in the visited network may handle user session management and user plane function respectively. LBO roaming may provide lower latency and more efficient data transmission based on the user data not flowing via the home network.

HR PDU sessions may be established when the WTRU is in the visited network. During PDU session establishment, a UPF that is part of the home network may be selected to serve as an anchor for the PDU session. User data traffic may move through the home network passing through the UPF before reaching the external data network. An SMF in the home network may handle user session management and the UPF in the home network may handle the user plane functions. HR roaming may provide better control and visibility over user data traffic for the home network operator based on the user data flowing via the home network.

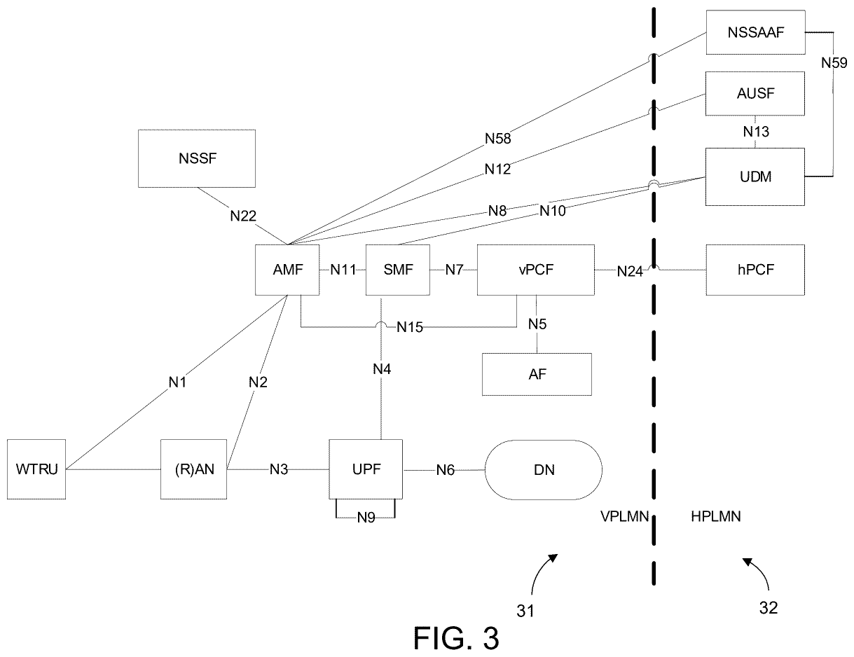

FIG. 3 is a diagram illustrating the 5G system roaming architecture. A local break out scenario between a VPLMN 31 and HPLMN 32 is illustrated using the reference point representation N1-N13, N22, N24, N58, N59.

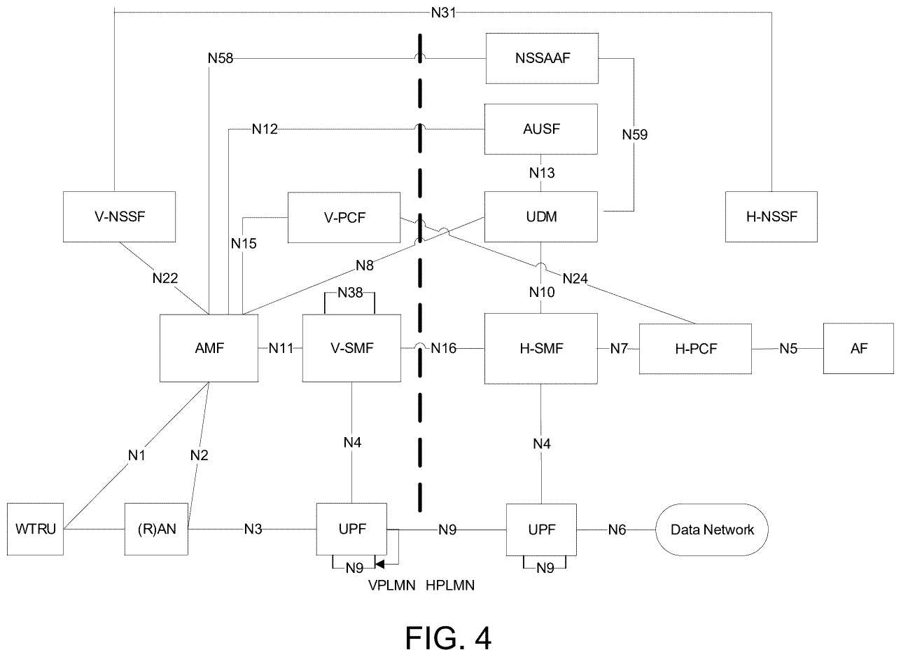

FIG. 4 is a diagram illustrating the 5G system roaming architecture in the case of home routed scenario. The reference point representation N1-N13, N15, N16, N22, N24, N31, N38, N58, N59 shows how various network functions may interact with each other.

5GS does not support roaming between the SNPNs and PLMNs. For single radio mobile devices (WTRUs) service continuity is not supported when the WTRU is moving between SNPN and PLMN. Some SNPNs may remain (e.g., entirely) isolated, some other SNPNs, such as e.g., those in logistics, transportation, and other industries may require improved interworking with PLMNs for e.g., seamless mobility and service continuity. The seamless mobility for authorized WTRUs which may be using a universal integrated circuit card (UICC) with subscriber identity module (SIM), e.g., UICC with SIM (USIM) with globally unique international mobile subscriber identity (IMSI) may be preferrable in various examples.

Embodiments described herein may allow to (e.g., enhance the 5G system to) ensure seamless mobility, service continuity, enhanced coverage and capacity for WTRUs using USIMs with globally unique IMSIs, while transitioning between PLMNs and SNPNs.

5G system enhancements are described herein that may enable roaming between the SNPN and PLMN. The interworking between the SNPN and PLMN may further enable seamless mobility and service continuity for the WTRUs while transitioning between the SNPNs and PLMNs. To enable the seamless mobility and service continuity a new unified network selection mode is described in the WTRU and may be mutually supported by the WTRU and the network. The network may provide the WTRU with (e.g., new) information elements such as any of an (e.g., enhanced) tracking area list, equivalent networks, preferred networks list to enable idle and connected mode mobility between the SNPN and PLMNs. Further network interfaces between the 5G network functions (NFs) (AMF/SMF/policy control function (PCF)) of SNPN and PLMN may be enabled, taking into consideration any of roaming agreements, service level agreements (SLAs) and business arrangements among the SNPN and PLMN operators. While operating in this new unified network selection mode, the WTRU may treat cells of the PLMN or SNPN as suitable candidate cells to access normal services from the network and can seamlessly switch between the cells from PLMN/SNPN based on the cells being part of the (e.g., enhanced) tracking area identity (TAI) list for seamless mobility. The WTRU may not (e.g., have to) be explicitly operating in either of the PLMN selection mode or SNPN access operation mode to select and register to PLMN/SNPN. The unified network selection mode may further ensure that the end user can easily find a hosting network (CAG vs SNPN) without switching modes and may be able to seamlessly continue with the localized services across hosting networks (CAG cells vs SNPN).

### 5GS Architecture Enhancements to Support SNPN-PLMN Interworking

A standalone non-public network (SNPN) may be operated by the NPN operator and may not rely on network functions provided by a PLMN. The SNPN 5GS deployment may be similar to the PLMN 5GS deployment for non-roaming architecture as shown at FIG. 2.

To enable roaming and coordination between the SNPN and PLMN the 5GS roaming architecture for roaming between a VPLMN and HPLMN may be extended to SNPNs, where interfaces between the different network functions to enable roaming may be enabled, such as, for example, N14 to enable communication between the AMFs from SNPN and PLMN, N24 reference point between the PCF in the visited network (SNPN) and the PCF in the home network, N16 reference point between two SMFs, (in roaming case between SMF in the visited network and the SMF in the home network), N32 reference point between a security edge protection proxy (SEPP) in one PLMN or SNPN and a SEPP in another PLMN or SNPN.

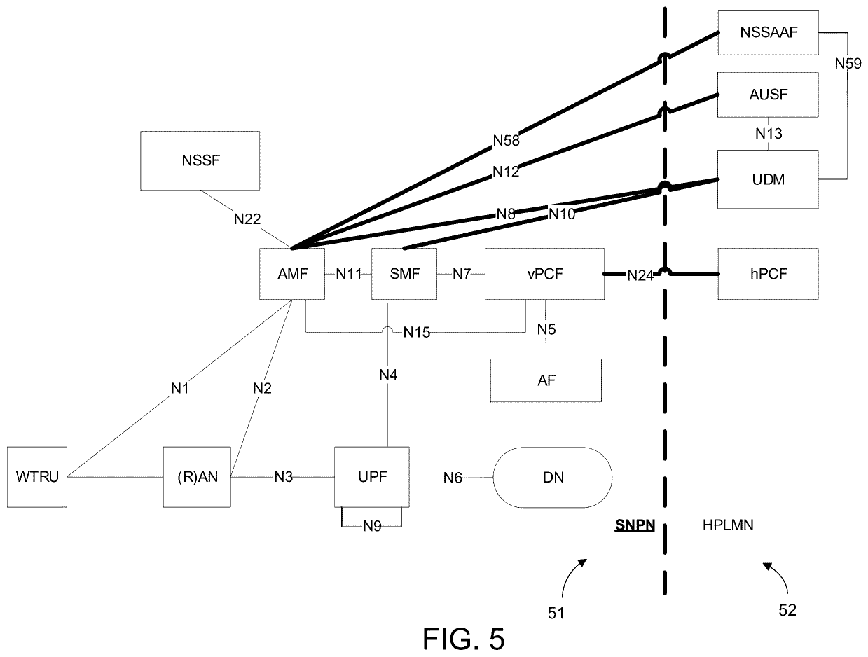

FIG. 5 is a diagram illustrating the 5G system roaming architecture in the case of local break out scenario using the reference point representation for SNPN and PLMN interworking. In FIG. 5, the PLMN is the home PLMN 52 and the SNPN 51 is a visited SNPN. The interfaces to be extended N8, N10, N12, N24, N58 are bolded in FIG. 5.

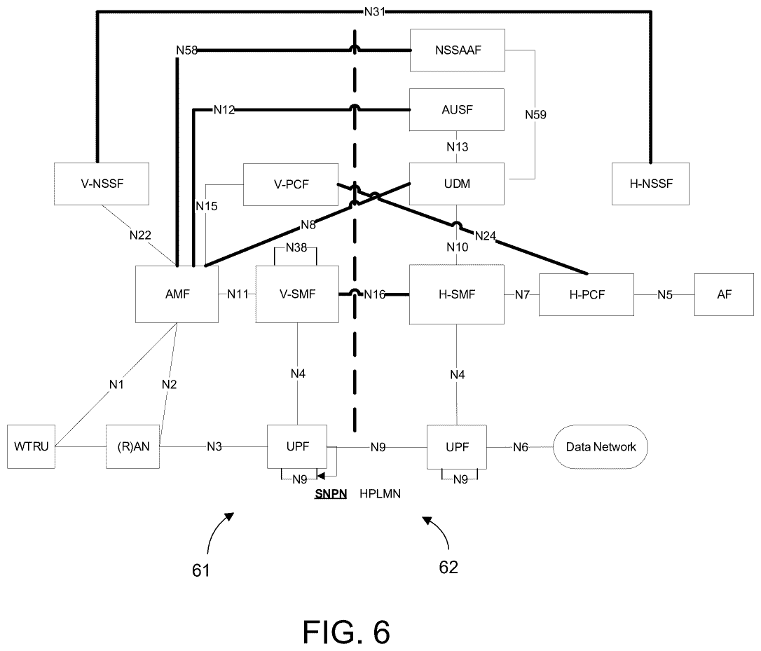

FIG. 6 is a diagram illustrating the 5G system roaming architecture in the case of home routed scenario using the reference point representation for SNPN and PLMN interworking. In FIG. 6, PLMN is the home PLMN 62 and the SNPN 61 is a visited SNPN. The interfaces to be extended N8, N12, N16, N24, N31, N58 are bolded in FIG. 6.

To enable the roaming and interworking between the SNPNs and PLMNs, the subscription management may be unified. In an example, the integrated subscription information may be maintained by the HPLMN (unified data management (UDM)/unified data repository (UDR)) and interworking and roaming may (e.g., only) be possible for the WTRUs whose credentials e.g., USIM/IMSI may be known and allocated by the HPLMN.

SNPNs may have a private authentication framework e.g., the WTRUs may be authenticated by the credentials issued by the SNPN. To enable interworking of the SNPN and PLMNs, the authentication framework may be unified e.g., the PLMN authentication framework may be used across SNPNs and PLMNs. The WTRU may use single credentials e.g. USIM/globally unique IMSI to support authentication mechanism for SNPN and PLMN. In an example, SNPNs credentials holders may be integrated into the HPLMNs UDM/UDR.

Policy and quality of service management may require that the PCF's from SNPN/PLMN may have interface established to exchange policy related information.

In an example, the network interfaces between the SNPN and PLMN may be enabled. Any of the service and session continuity may follow the existing logic of session handover between VPLMN and HPLMN, extended to SNPN <->PLMN. The N14 interface between the AMFs (AMFs of SNPN and PLMN) may enable communication between the AMFs to transfer WTRU session details (any of PDU session ID, QoS rules), mobility and security context from the source AMF to the target AMF during the handover.

### Registration and Mobility Management Aspects for SNPN-PLMN Interworking

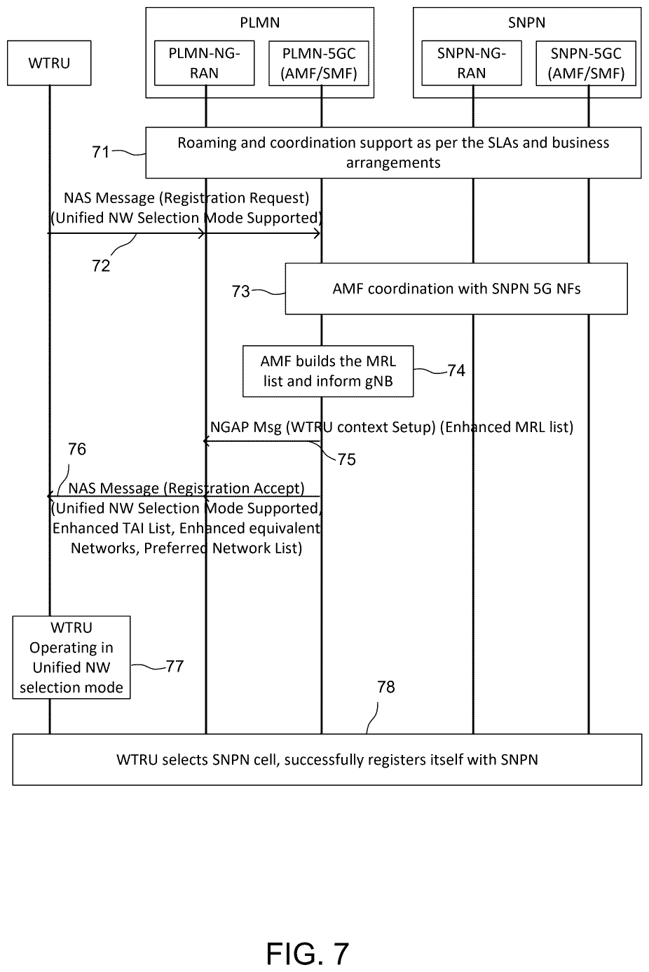

FIG. 7 is a diagram illustrating registration and mobility management aspects for SNPN-PLMN interworking.

As shown at block 71, interfaces between the SNPN and PLMN may be updated and enabled to support roaming between the SNPN and PLMN, taking into consideration any of SLAs and business agreements between the PLMN/SNPN operators.

As shown at 72, The WTRU may be camped on a suitable cell of the PLMN which can provide (e.g., normal) services to the WTRU. The WTRU may send a (e.g., NAS) message (which may be referred to herein a request message) to the AMF indicating a WTRU capability to support unified network selection mode. A WTRU operating in the unified network selection mode, may select cells belonging to any of a SNPN and a PLMN. A WTRU not operating in the unified network selection mode, may be either operating in SNPN access operation mode or in PLMN selection mode to select cells from either SNPN or PLMN respectively. A WTRU indicating support for unified network selection mode, may be capable of camping/registering and accessing services via SNPN, e.g., the WTRU may be SNPN enabled and capable. An application that may run in the terminal equipment (TE) part of the WTRU may send an indication to the mobile termination (MT) part of the WTRU indicating to enter the new mode. The indication may be sent from the TE to the MT via an AT command. The application in the TE may determine to enter the mode based on input from a user (e.g., via a graphical user interface (GUI)). This input may be used by the NAS mobility management (MM) layer to indicate WTRU support for this new mode e.g., WTRU capabilities to support unified network selection mode as part of the (e.g., NAS) message.

The (e.g., NAS) message sent by the WTRU may be an initial NAS message such as e.g., a registration request. The (e.g., NAS) message may be another NAS control plane signaling message such as e.g., any of a UL NAS transport message, a mobility registration request message, and a service request message, etc. In an example, the WTRU may provide location information of the WTRU to the AMF along with the NAS message. In another example, the WTRU may report any of detected SNPNs and desired SNPNs and, for example, include them as part of the (e.g., NAS) message sent to the AMF. The WTRU may include, in the (e.g., NAS) message, the identities of SNPNs that the WTRU may expect to connect to in order to access services. A reason for including the SNPN identities in the (e.g., NAS) message may include that the information can be used by (e.g., may assist) the network to determine which SNPNs the WTRU may expect to be able to access. For example, the WTRU may be authorized to access multiple SNPNs and may (e.g., only need to) access one particular SNPN at the current time.

As shown at block 73, the AMF, on reception of the (e.g., NAS) message from the WTRU, may determine the location of the WTRU. In an example, this determination may be based on the location information provided by the WTRU in the (e.g., NAS) message. In another example, the AMF may use (e.g., invoke) a location function in the 5GS to determine the WTRU location. The AMF may use the location information of the WTRU, e.g., along with provisioned policies it may have with the SNPNs to determine the availability of SNPNs as per the WTRU location. The available SNPNs which may have roaming agreements with the PLMN may be used by the AMF to construct any of the mobility restriction list, the (e.g., enhanced) TAI list, the (e.g., enhanced) equivalent network list, and the (e.g., enhanced) network selection list.

In another example, this determination may be done by other 5G NFs such as e.g., UDM/external application function (AF), which may take as input, for example, WTRU current location and subscription information (generic public subscription identifier (GPSI)/subscription concealed identifier (SUCI) etc.) of the WTRU, e.g., along with the SLA information on the SNPNs to determine/construct any of the mobility restriction list, the (e.g., enhanced) TAI list, the (e.g., enhanced) equivalent network list, and the (e.g., enhanced) network selection list.

As shown at block 74, the AMF may construct (e.g., determine) the mobility restriction list (MRL) and may provide it to the NG-RAN node via a next generation application protocol (NGAP) message. The mobility restriction list may contain information about the roaming restrictions which may include information about any of the allowed PLMNs/SNPNs, (e.g., enhanced) equivalent network list, (e.g., enhanced) TAI list as described herein.

As shown at 75, the AMF may provide the mobility restriction list to the gNB/NG-RAN via any of an initial WTRU context procedure and a WTRU context modification procedure. The NG-RAN/gNB may use the mobility restriction list to enforce connected mode mobility restrictions for the WTRU. For example, the gNB may use the MRL to decide (e.g., determine) whether to permit (e.g., allow) the handover to a target PLMN/SNPN cell.

As shown at 76, the AMF may respond (e.g., to the WTRU) with a (e.g., NAS) response message such as e.g., any of a registration accept message, a downlink NAS transport message, and a service accept message, etc. The AMF may include/indicate in the (e.g., NAS) response message any of (i) that unified network selection mode may be supported by the AMF, (ii) an (e.g., enhanced) TAI list, (iii) an (e.g., enhanced) equivalent network list and an (e.g., enhanced) network selection list.

In an example, indicating that unified network selection mode may be supported by the AMF may indicate that the AMF may have roaming agreements with SNPN and may allow the WTRU to operate in the unified network selection mode enabling to camp on any available suitable cells belonging to SNPN/PLMN.

In an example, an (e.g., enhanced) TAI list may comprise TAIs from (e.g., both) PLMN and SNPNs. The TAI list may ensure that the TAIs contained in the list may belong to the PLMNs/SNPNs which may be considered equivalent to each other. To reduce the tracking area updating signaling within the 5GS, the AMF may assign several tracking areas to the WTRU as part of the (e.g., enhanced) TAI list. The WTRU may consider itself registered to a list of tracking areas and may not (e.g., need to) trigger the registration procedure for mobility and periodic registration update used for mobility (e.g., “mobility registration updating” in the registration request message) as long as the WTRU may stay in one of the tracking areas of the (e.g., enhanced) TAI list received from the AMF.

In an example, an (e.g., enhanced) equivalent network list may comprise the list of PLMN/SNPNs which may be considered equivalent to each other. From the WTRU perspective they may be same/similar networks, and the WTRU may seamlessly roam among them and may treat them as same for the purpose of idle mode cell selection and reselection.

In an example, an (e.g., enhanced) network selection list may comprise a prioritized list of (e.g., PLMNs/SNPNs) networks configured by the home operator (HPLMN) taking into consideration (e.g., based on) provisioned policies that may have been received from other PLMN/SNPN operators.

As shown at block 77, at the reception of the (e.g., NAS) message from the AMF indicating that unified network selection mode may be supported by the AMF, the WTRU may start to operate in the unified network selection mode. While operating in the unified network selection mode, the WTRU may treat cells of the PLMN or SNPN as suitable candidate cells to access normal services from the network and may seamlessly switch between the cells from PLMN/SNPN based on the cells being part of the (e.g., enhanced) TAI list for seamless mobility. The WTRU may not (e.g., have to) be explicitly operating in either of the PLMN selection mode or SNPN access operation mode to select and register to PLMN/SNPN. As localized services can be provided by the SNPN or PNI-NPN, a unified network selection mode may enable the end user to find a hosting network (CAG vs SNPN) without switching modes and may be able to seamlessly continue (e.g., operate) with the localized services across hosting networks (CAG vs SNPN) or transition from SNPN to PLMN.

As shown at block 78, the WTRU may operate in the unified network selection mode. Based on radio conditions or mobility, the current camped PLMN cell may no longer be suitable. The WTRU may perform the search and selection for the most suitable cell and may find a cell belonging to an SNPN which may be part of the (e.g., enhanced) network selection list. The WTRU may successfully camp on the cell and may register itself with the SNPN using the PLMN credentials (e.g., used on the PLMN network), such as e.g., USIM with globally unique IMSI. WTRU operation in unified network selection mode shown at block 78 may be enhanced by PLMN independent of PLMN cell suitability. The PLMN may maintain WTRU information received in the (e.g., NAS) message (registration request) shown at 72 beyond the (e.g., NAS) message (registration accept) shown at 76, in order to provide enhanced services to WTRU directly or indirectly. For example, the PLMN may be able to coordinate services relying on public subscription (e.g. based on PLMN UDR/UDM, AUSF functionality) with those provided by SNPN exclusively for non-public subscribers. The AMF of the SNPN may query the UDM/UDR of the PLMN to obtain information about what services the WTRU may be authorized to access. The information about what services the WTRU may be allowed to access may be configured in the UDM/UDR based on what detected SNPNs and desired SNPNs may have been indicated by the WTRU in the (e.g., NAS) message (registration request) shown at 72.

In an example where the SNPN cell was part of the (e.g., enhanced) TAI list, or the SNPN belongs to the (e.g., enhanced) equivalent network list, the WTRU transition to the SNPN cell may be seamless and the WTRU may not (e.g., be required to) trigger a mobility registration procedure.

In an embodiment, if there is an update to any of the mobility restriction list, (e.g., enhanced) TAI list, (e.g., enhanced) equivalent network list, and (e.g., enhanced) network selection list, the AMF/5G NF may relay this updated information to any of the WTRU and gNB via any of NAS signaling messages (e.g., any of downlink NAS transport, WTRU configuration update command etc.) and NGAP messages (e.g., WTRU context modification message) using existing procedures.

In an example where an initial camping and registration may be carried out on an SNPN cell instead of the PLMN cell as described in FIG. 7, the procedure may be similar with few changes, such as, for example, the AMF may be located in the SNPN and the UDM may be located in the HPLMN. The AMF in the SNPN may coordinate with the UDM and other 5G NFs of the HPLMN to construct and provide any of the mobility restriction list, the (e.g., enhanced) TAI list, the (e.g., enhanced) equivalent network list, and the (e.g., enhanced) network selection list, to the gNB/WTRU respectively.

In an embodiment, the WTRU may be operating in the unified network selection mode and there may be an overlap of the cell coverage from (e.g., both) an SNPN and a PLMN. The cells from SNPN and PLMN may have good radio conditions, suitable for the cell selection and reselection purpose. In an example, the network may expect (e.g., ensure) that the WTRU may choose either an SNPN or PLMN cell and that the WTRU may not ping pong (e.g., alternate) between these cells. In another example, the network may expect (e.g., ensure) that WTRU may stay on the non-preferred cell. There may be an example where, in a warehouse the network may expect the WTRU to choose an SNPN cell over the macro cell of the PLMN, e.g., despite the macro cell from PLMN having equally good radio conditions as compared to the SNPN cell in the warehouse.

To achieve the above-described expectation, the network may reject the registration request from the WTRU with any of existing cause codes and a new cause code which may disable/forbid the camped cell (e.g., an SNPN cell or a PLMN cell) for a (e.g., certain) duration and make it not suitable for the purpose of cell selection and reselection. With this mechanism the network may ensure that the WTRU may choose (e.g., select) the right (e.g., expected) cell to access services as per the network preference. As part of this procedure, the WTRU may send a registration request if it (re)selects a cell that is of a different type than its current serving cell. For example, if the WTRU is currently camped on a PLMN cell (alternatively an SNPN cell) and the WTRU reselects an SNPN cell (alternatively a PLMN cell) the WTRU may send a registration request message. The WTRU may send this registration request message even if the current serving cell and the reselected cell are in the same TA or are part of the same (e.g., enhanced) TAI list.

In another example, the network may configure the (e.g., enhanced) TAI list provided to the WTRU to resolve (e.g., address) the overlap issues e.g., the TAI list may contain either TAIS from SNPN or PLMN for the overlap areas.

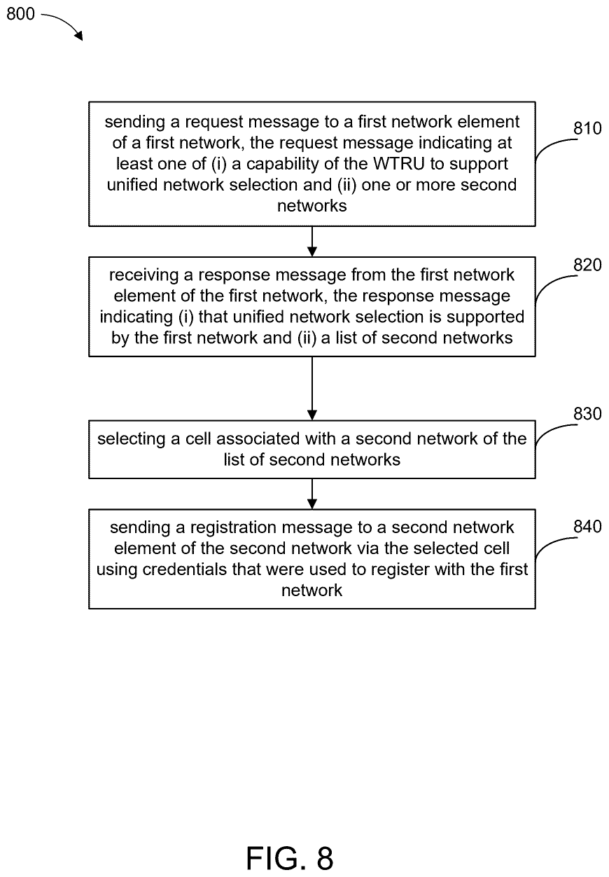

FIG. 8 is a diagram illustrating an example method 800 for SNPN-PLMN interworking, implemented in a WTRU. The WTRU may include circuitry including a transmitter, a receiver, a processor, and memory. The WTRU may be configured to carry out the method 800. As shown at block 810, the method 800 may include sending a request message to a first network element of a first network. In various embodiments, the request message may indicate at least one of (i) a capability of the WTRU to support unified network selection and (ii) one or more second networks. As shown at block 820, the method 800 may include receiving a response message from the first network element of the first network. In various embodiments, the response message may indicate (i) that unified network selection may be supported by the first network and (ii) a list of second networks. As shown at block 830, the method 800 may include selecting a cell associated with a second network of the list of second networks. As shown at block 840, the method 800 may include sending a registration message to a second network element of the second network via the selected cell using credentials that may have been used to register with the first network.

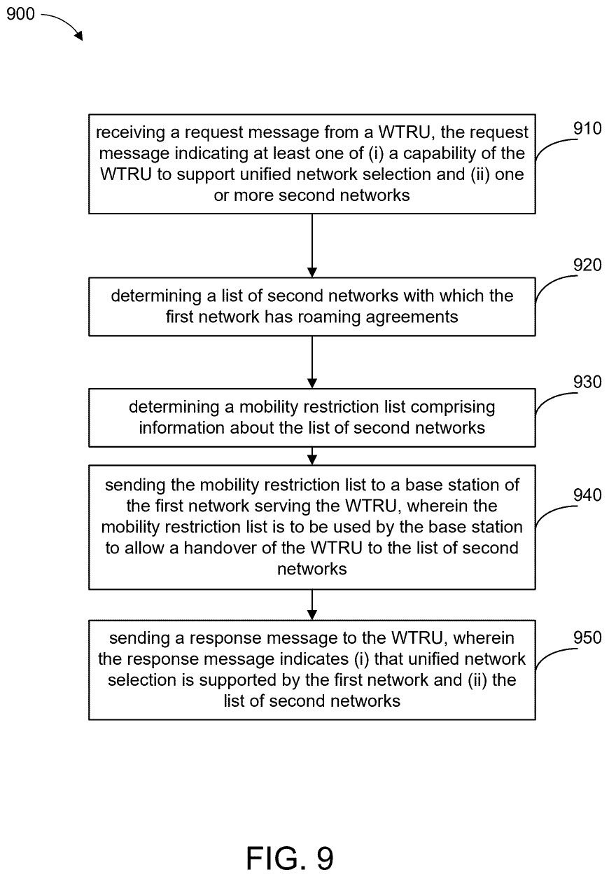

FIG. 9 is a diagram illustrating an example method 900 for SNPN-PLMN interworking, implemented in a network element of a first network. The network element may include circuitry including a transmitter, a receiver, a processor, and memory. The network element may be configured to carry out the method 900. As shown at block 910, the method 900 may include receiving a request message from a WTRU. In various embodiments, the request message may indicate at least one of (i) a capability of the WTRU to support unified network selection and (ii) one or more second networks. As shown at block 920, the method 900 may include determining a list of second networks with which the first network may have roaming agreements. As shown at block 930, the method 900 may include determining a mobility restriction list comprising information about the list of second networks. As shown at block 940, the method 900 may include sending the mobility restriction list to a base station of the first network serving the WTRU. In various embodiments, the mobility restriction list may be to be used by the base station to allow a handover of the WTRU to the list of second networks. As shown at block 950, the method 900 may include sending a response message to the WTRU. In various embodiments, the response message may indicate (i) that unified network selection may be supported by the first network and (ii) the list of second networks.

In various embodiments, the request message may include an explicit indication of the capability of the WTRU to support unified network selection.

In various embodiments, the request message may include one or more second networks which may implicitly indicate to the first network element the capability of the WTRU to support unified network selection.

In various embodiments, the method 800 may further include camping on the selected cell associated with the second network.

In various embodiments, the method 800 may further include detecting the one or more second networks.

In various embodiments, the request message may indicate that the one or more second networks may have been detected by the WTRU.

In various embodiments, the one or more second networks may comprise networks that the WTRU may be expecting to connect to.

In various embodiments, the request message may indicate that the one or more second networks may comprise networks that the WTRU may be expecting to connect to.

In various embodiments, the request message may indicate a list of tracking areas.

In various embodiments, the request message may comprise location information associated with the WTRU.

In various embodiments, the list of second networks may be a prioritized list based on provisioning policies.

In various embodiments, the request message may indicate the one or more second networks, and wherein the list of second networks may comprise at least one second network of the one or more second networks.

In various embodiments, the unified network selection being supported by the first network may indicate that there may be roaming agreements between the first network and the list of second networks, and that the WTRU may be enabled to camp and register on any of the first network and the list of second networks.

In various embodiments, the unified network selection being supported by the WTRU may indicate that the WTRU may be capable to camp and register on any of the first network and the list of second networks.

In various embodiments, the request message may be NAS message.

In various embodiments, the request message may be any of a registration request message, an uplink NAS transport message, a mobility registration request message, and a service request message.

In various embodiments, the response message may be a NAS message.

In various embodiments, the response message may be any of a registration accept message, downlink NAS transport message, and a service accept message.

In various embodiments, the first network may be a PLMN.

In various embodiments, the second network may be SNPN.

In various embodiments, any of the network element, the first network element and the second network element comprise an AMF.

While not explicitly described, embodiments described herein may be employed in any combination or sub-combination. For example, the present principles are not limited to the described variants, and any arrangement of variants and embodiments can be used.

Besides, any characteristic, variant or embodiment described for a method is compatible with an apparatus device comprising means for processing the disclosed method, with a device comprising circuitry, including any of a transmitter, a receiver, a processor, and memory, the circuitry being operable (e.g., configured) to process the disclosed method, with a computer program product comprising program code instructions and with a non-transitory computer-readable storage medium storing program instructions. Besides, any characteristic, variant or embodiment described for a WTRU is compatible with an (e.g., infrastructure) network element of the cellular network.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

The content of each of the following references is incorporated by reference herein in its entirety:
3GPP TS 23.501, “System architecture for the 5G System (5GS); Stage 2 (Release 19)”, v19.1.0
3GPP TS 22.261, “Service requirements for the 5G system; Stage 1 (Release 19)”, v19.8.0
3GPP TS 23.502, “Procedures for the 5G System (5GS); Stage 2 (Release 19)”, v 19.1.0
3GPP TS 24.501, “Non-Access-Stratum (NAS) protocol for 5G System (5GS); Stage 3; (Release 19)”, v19.0.0
3GPP TS 23.122, “Non-Access-Stratum (NAS) functions related to Mobile Station (MS) in idle mode (Release 19)”, v19.0.0
3GPP S1-203276, “New SID: Study on 5G Networks Providing Access to Localized Services”, 3GPP TSG-SA WG1 Meeting #91-e, S1-203276, E-meeting (Aug. 24-Sep. 2, 2020
3GPP SP- 221340 , “Revised WID: Enhanced support of Non-Public Networks Phase 2 (eNPN_Ph2)”, TSG SA Meeting #SP-98E, SP-221340, Electronic meeting (December 13-19, 2022).

1. A wireless transmit/receive unit (WTRU) comprising circuitry, including a transmitter, a receiver, a processor, and memory, configured to:
send a request message to a first network element of a first network, wherein the request message indicates at least one of (i) a capability of the WTRU to support unified network selection and (ii) one or more second networks;
receive a response message from the first network element of the first network, wherein the response message indicates (i) that unified network selection is supported by the first network and (ii) a list of second networks ;
select a cell associated with a second network of the list of second networks; and
send a registration message to a second network element of the second network via the selected cell using credentials that were used to register with the first network.

2. The WTRU of claim 1, further configured to camp on the selected cell associated with the second network.

3. The WTRU of claim 1, further configured to detect the one or more second networks.

4. The WTRU of claim 3, wherein the request message indicates that the one or more second networks have been detected by the WTRU.

5. The WTRU of claim 1, wherein the one or more second networks comprise networks that the WTRU is expecting to connect to.

6. The WTRU of claim 1, wherein the request message indicates that the one or more second networks comprise networks that the WTRU is expecting to connect to.

7. The WTRU of claim 1, wherein the request message indicates a list of tracking areas.

8. The WTRU of claim 1, wherein the request message comprises location information associated with the WTRU.

9. The WTRU of claim 1, wherein the list of second networks is a prioritized list based on provisioning policies.

10. The WTRU of claims 1, wherein the request message indicates the one or more second networks, and wherein the list of second networks comprises at least one second network of the one or more second networks.

11. The WTRU of claims 1, wherein the unified network selection being supported by the first network indicates that there are roaming agreements between the first network and the list of second networks, and that the WTRU is enabled to camp and register on any of the first network and the list of second networks.

12. The WTRU of claim 1, wherein the unified network selection being supported by the WTRU indicates that the WTRU is capable to camp and register on any of the first network and the list of second networks.

13. The WTRU of claim 1, wherein the request message is a non-access stratum (NAS) message.

14. The WTRU of claim 1, wherein the request message is any of a registration request message, an uplink NAS transport message, a mobility registration request message, and a service request message.

15. The WTRU of claim 1, wherein the response message is a non-access stratum (NAS) message.

16. The WTRU of claim 1, wherein the response message is any of a registration accept message, downlink NAS transport message, and a service accept message.

17. The WTRU of claim 1, wherein the first network is a public land mobile network.

18. The WTRU of claim 1, wherein the second network is a standalone non-public network.

19. A method implemented in a wireless transmit/receive unit (WTRU), the method comprising:
sending a request message to a first network element of a first network, wherein the request message indicates at least one of (i) a capability of the WTRU to support unified network selection and (ii) one or more second networks;
receiving a response message from the first network element of the first network, wherein the response message indicates (i) that unified network selection is supported by the first network and (ii) a list of second networks;
selecting a cell associated with a second network of the list of second networks; and
sending a registration message to a second network element of the second network via the selected cell using credentials that were used to register with the first network.

20. A network element of a first network comprising circuitry, including a transmitter, a receiver, a processor, and memory, configured to:
receive a request message from a wireless transmit/receive unit (WTRU), wherein the request message indicates at least one of (i) a capability of the WTRU to support unified network selection and (ii) one or more second networks;
determine a list of second networks with which the first network has roaming agreements;
determine a mobility restriction list comprising information about the list of second networks;
send the mobility restriction list to a base station of the first network serving the WTRU, wherein the mobility restriction list is to be used by the base station to allow a handover of the WTRU to the list of second networks; and
send a response message to the WTRU, wherein the response message indicates (i) that unified network selection is supported by the first network and (ii) the list of second networks.
